(19) United States
(12) Patent Application Publication
(10) Pub. No.: US 2009/0049944 A1
(43) Pub. Date: Feb. 26, 2009

(54) MICROMANIPULATOR FOR MOVING A PROBE

(75) Inventors: Jorg Kiesewetter, Thiendorf OT Sacka (DE); Stojan Kanev, Thiendorf OT Sacka (DE); Lutz Junker, Lutherstadt Eisleben (DE); Stefan Kreissig, Venusberg (DE)

Correspondence Address: HESLIN ROTHENBERG FARLEY & MESITI PC, 5 COLUMBIA CIRCLE, ALBANY, NY, 12203, US

(73) Assignee: SUSS MicroTec Test Systems GmbH, Sacka (DE)

(21) Appl. No.: 12/022,261

(22) Filed: Jan. 30, 2008

(30) Foreign Application Priority Data
Aug. 21, 2007 (DE) 10 2007 039 506.1

(51) Int. Cl. B25J 7/00

(52) U.S. Cl. 74/479.01

(57) ABSTRACT

A micromanipulator for moving a probe comprises two elements which are mechanically connected to one another in such a way that one element can be moved relative to other element. The movement of the element occurs as a result of the pressure change of a fluid which acts upon an actuator which is in mechanical contact to a mobile element or to an element moving on a surface segment.

### BACKGROUND OF THE INVENTION

The present invention refers to systems for probing electronic components where different probes are moved with a constructive element for positioning and producing a locally limited electrical, mechanical, optical as well as thermal contact. All elements comprising an integrated circuit are considered as electronic elements. The input signals and the output signals can have a different characteristic. Namely, they can be electric, optic, thermal, mechanic or pneumatic.

The probes are hold individually, directly or combined by probe heads in groups on probe cards. At first, the contacting of components requires the alignment of the probes relative to each other, and to a referencing direction of the arrangement of the components or of one component in order to be able to contact simultaneously at least two probes, or probes of at least two probe cards on the contact surface of a component. For that, the arrangement of the probes is brought into a line with the arrangement of the contact surfaces. Furthermore, this alignment serves to raster a bigger number of components, e.g. on a wafer or if arranged in a raster on a beam.

Such an alignment is often obtained by manipulators which are part of a probe head, and which have to meet the requirements of the resolution of the separate movements. With a further miniaturization of electronic components the requirements increase for the resolution and for the accuracy of the movements to be performed by the manipulators. The movements from which the alignment and the contacting result, can be carried out in all three directions of space x, y and z. Wherein, also an angular alignment is possible, which results from at least two directional components. In the following, the x and the y directions will illustrate the horizontal plane and the z direction will be vertically thereto.

Because the probing takes place within an enclosure for instance in order to determine the environmental conditions as defined by pressure, temperature or lighting or to achieve an EMI shielding, the orientation of the probe as well as the contacting are also carried out within the enclosure. Thus it is necessary that the manipulators are operable under the respective environmental conditions also ensuring the required accuracy, and allowing to be screened from the component as far as necessary.

### SUMMARY OF THE INVENTION

In accordance with the present invention, a device is provided for moving probes within a range of a few micrometers to a few millimeters. This micromanipulator can be incorporated into different probing systems and can be adjusted to the existing probe beams. For instance, it is possible to connect the micromanipulator directly to a probe head or by suitable holding means. Furthermore, the probes can be mounted directly onto the micromanipulator, or by means of probe cards or of special holding means, for instance to overcome a gap between the micromanipulator and the contact surface of the component. A criterion for a possible arrangement of a micromanipulator is the movement to be carried out. The movement can be pivoting or linear. Wherein in case of the pivoting movement the distance between the head of the probe and the turning point of the movement influences considerably the movement carried out by the probe head. Furthermore, the mounting of a manipulator is influenced, for instance, also by constructing the probing system or probes, as well as by the different requirements for the observability of the probing or for the parameters of the probing. In dependency of those conditions for the mounting, or of the amount of probes to be moved by a micromanipulator, or as well of the amount of the micromanipulators to be arranged within a probing system, the size of the micromanipulators is adjustable.

Generally, the described micromanipulator allows the surveillance of the probing, including the surveillance of the orientation, for instance, also in direct proximity to the operating position, and of the contacting procedure, as well as the operating in different environment conditions.

The resolution and the accuracy are to be adjusted to the respective requirements through the arrangement of the micromanipulator in the probing system, through its dimensioning, and through the fluid current driving the micromanipulator. Adaptations to the thermal conditions are possible due to the choice of fluid, which can be either liquid or gaseous, as well as due to its temperature. For instance a heat input in the micromanipulator can result from or be prevented by the adequate tempering of the fluid, or by the choice of the fluid. Furthermore, the movement occurs as currentless, by which an electromagnetically influence on the measurement signals is avoided.

### BRIEF DESCRIPTION OF THE DRAWINGS

The present invention will be more completely understood through the following detailed description, which should be read in conjunction with the attached drawings. In this description, like numbers refer to similar elements within various embodiments of the present invention. Within this detailed description, the claimed micromanipulator will be explained with respect to preferred embodiments. However, the skilled artisan will readily appreciate that the systems described herein are merely exemplary and that variations can be made without departing from the spirit and scope of the invention.

FIG. 1 is a perspective illustration of a micromanipulator with an actuator and an HF-probe.

FIG. 2 is a lateral view of a micromanipulator as in FIG. 1

FIG. 3 represents a combination of the manipulator as in FIG. 1 with another manipulator in top view.

FIG. 4 is a sectional representation of a micromanipulator embodiment with actuator with a probe card comprising more probes.

FIG. 5 is another embodiment of a micromanipulator without actuator also in lateral view.

### DETAILED DESCRIPTION OF THE INVENTION

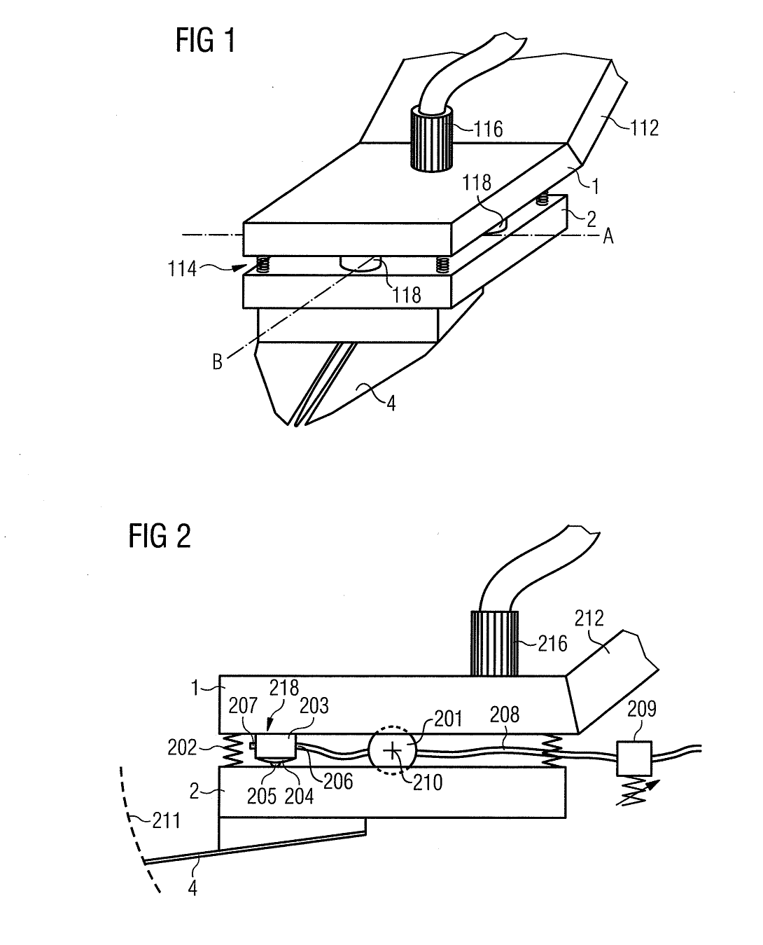

The micromanipulator as in FIG. 1 contains a base element 1 and a positioning element 2. The base element 1 is connected to a not represented probing system by a beam 102. In the represented embodiment example base element 1 and positioning element 2 are platelike and are positioned opposite to one another with a clearance in between, whose dimensions in initial state between the two plates is approximately even. The dimension of the clearance 104 depends on the type and size of the amplitude of the movement to be carried out, which is noticeable in the following display.

A probe 4 is mounted onto the side of the positioning element 2 which is turned away from the base element. In the represented embodiment, the base element 1 is over the positioning element, and the probe 4 is arranged at the rear side of the micromanipulator. A junction 116 for a cable, which connects the probe 4 to a measuring instrument (not represented), is arranged at the upper side of the base element 1.

It is obvious that with a micromanipulator being available as an interchangeable component of a probing system suitable for different measurements, the arrangement and the basic assembly can differ from the representation in FIG. 1. For instance, a rotation of the micromanipulator in space around any angle is possible, as well as another design of the base element 1 or the positioning element 2, or of both of the elements. Also, different probes 4 can be mounted onto a micromanipulator, or a different junction 116 can be used. In the following, the designation of the base element 1 irrespective of its position relative to the positioning element 2 shall be identified as a component of the micromanipulator, through which a connection to the probing system is made. The component which is moved relative to the base element 1 shall be described as positioning element 2, irrespective of the fact that the micromanipulator itself might be moveable by the use of other components of the probing system and of further components connected to the positioning element 2.

There are two actuators 118 in the range of two adjoining outer edges of the base element 1 within the clearance 114 which is between the base element 1 and the positioning element 2.

As represented in FIG. 2, a pivotal connection 201 is also arranged within the clearance 214 as a mechanical connection of the two elements. The pivotal connection 201 allows a pivoting of the positioning element 2 relative to the base element. It is approximately in the middle of the base element 1, and approximately in the middle of the positioning element 2, so that a uniform pivoting of the positioning element 2 can occur in every possible direction. The pivoting can occur by means of the actuators 218 whose arrangement is chosen in such a way that the positioning element 2 can be pivoted around two horizontal axes A and B (FIG. 1), positioned in a right angle towards one another and which continue through the pivotal connection 201.

The base element 1 and the positioning element 2 are connected at the corners by means of the restoring elements 202, by which the positioning element 2 can be restored after an excursion away from the represented initial state, in which both elements are aligned approximately parallel to each other. In the represented embodiment example, the coil springs serve as restoring elements 202. Other types of springs such as spiral springs or gas springs or other restoring elements 202 which are flexible and develop the force necessary for restoring the positioning elements 2 to its previous state are used.

The actuators 218 in FIGS. 1 and 2 consist of a cylinder shaped hollow part 203 mounted with its base area onto the base element 1, and whose second base area is formed of a resilient membrane 204. Approximately in the middle of the membrane 204, a pusher 205 is arranged which touches the positioning element. The cylinder shaped hollow part 203 and the pusher 205 combined are dimensioned to the extent that with the touch of the positioning element 2 by the pusher 205 the membrane 204 is prestressed and a convexity is formed from the hollow part. The convexity is stressed by a pressure in the hollow part to the extent, that the resilience of the membrane 204 allows an enlargement as well as a decrease of the convexity, without irreversibly expanding the membrane 204 or fully relaxing it, and with it to loosen the contact between the pusher 205 and the positioning element.

The hollow part 203 has a fluid inlet 206 and a fluid outlet 207, wherein the fluid outlet 207 is formed as an opening through which the fluid can escape into the surrounding space. A gaseous fluid is led through the fluid inlet 206 through an inlet pipe 208 into the hollow part 203 with such a pressure, that depending on the size of the fluid outlet 207 proportionally to the size of the fluid inlet 206 an equilibrium condition is created between the compressive force of the pusher 205 and the restoring force of the springs 202. That results in the pusher 205 touching the positioning element 2 and remaining in its position, or moving to a defined degree into an initial state. The pressure of the fluid is set by a suitable valve as a control element 209.

The springs 202 are arranged in the same way as the membrane is so that the springs are already prestressed in their initial state, in order to push the positioning element 2 in a defined way against the pusher 205, and to oppose the compressive force of the pusher 205 in each position with a spring force.

In order to move the probe 4 away from the resting state, the pressure of the fluid is increased or reduced. The prestressing of the membrane 204 and of the springs 202 cause an enlargement or a decrease of the clearance between the positioning element 2 and the base element 1 so that the probe 4 moves with the positioning element 2 towards the base element 1.

The movement is carried out in an orbit 211 around a swivel axis 201 which is positioned vertically to the drawing sheet in the represented embodiment example. The movement consists of two different directional components depending on the distance between the swivel axes 201 and the heads of the probe 4. In the described movement these are the directional components of the drawing sheet, or according to the description above the z-direction and one of the x or y directions. These components are to be influenced by the construction of the micromanipulators, i.e. by the distance between the swivel axe 210 and the heads of the probe 4. The movement carried out by the head of probe 4 depends on the amplitude of the pusher 205 as well as on the ratio of the distances of the pusher 205 and the head of the probe 4 to the swivel axe 210.

The sensitivity of the micromanipulator can be for instance adjusted by help of the spring constant. Because with an enhanced spring force an increasing pressure modification is necessary for the excursion of the pusher 205.

The fluid outlet 207 functions as a defined leakage, and serves in this way to improve the dynamic of the control mode of the pressure regulation. Moreover, the influence of the temperature alterations within the probing system on the control mode is diminished, because variations of the fluid pressure due to the temperature alterations are compensated by the fluid outlet, and not by the control element 209. As far as the requirements allow with regard to the dynamic of the control loop or to the temperature adaptations, or these requirements are to be met for instance by the regulation configuration, the actuator can be designed in an alternative embodiment without a fluid outlet.

The second actuator 218 which is placed in relation to the pivotal connection 201 in an angle of 90° on another side between the base element 1 and the positioning element 2 (not visible in FIG. 2) has the same construction as described above including a separate inlet pipe 208 and a separate control element 209. Therefore, a movement is to be carried out by means of the actuator 218 on a plane that is vertically to the drawing sheet. Both movements can be carried out independently from each other, or can in a combined manner in order to orientate the probe 4 towards the x, y and z directions.

In another not further specified represented embodiment of the micromanipulator, the stiff segment of the hollow part facing the positioning element is connected to the rest of the hollow part by a bellow for the expansion of the latter towards the positioning element instead of the membrane, so that an expansion of the positioning element is viable by use of the said bellow. Depending on the design of the hollow part, the coupling element establishing the mechanical contact between the hollow element and the positioning element, can have alternatively, for instance, a spherical or flat shape. Also, the coupling element can be a component of the hollow part. The said mechanical contact to the coupling element is subject of no other limitations except those necessary for warranting the contact, irrespective of the volume modification of the hollow part that is to be achieved by the actuator. Thus, a form-closed contact as well as an actuated contact is applicable.

In another also not further specified represented embodiment, the fluid escaping from the fluid outlet 207 is fed to a fluid circuit in order to prevent a contamination of the probing system through the fluid.

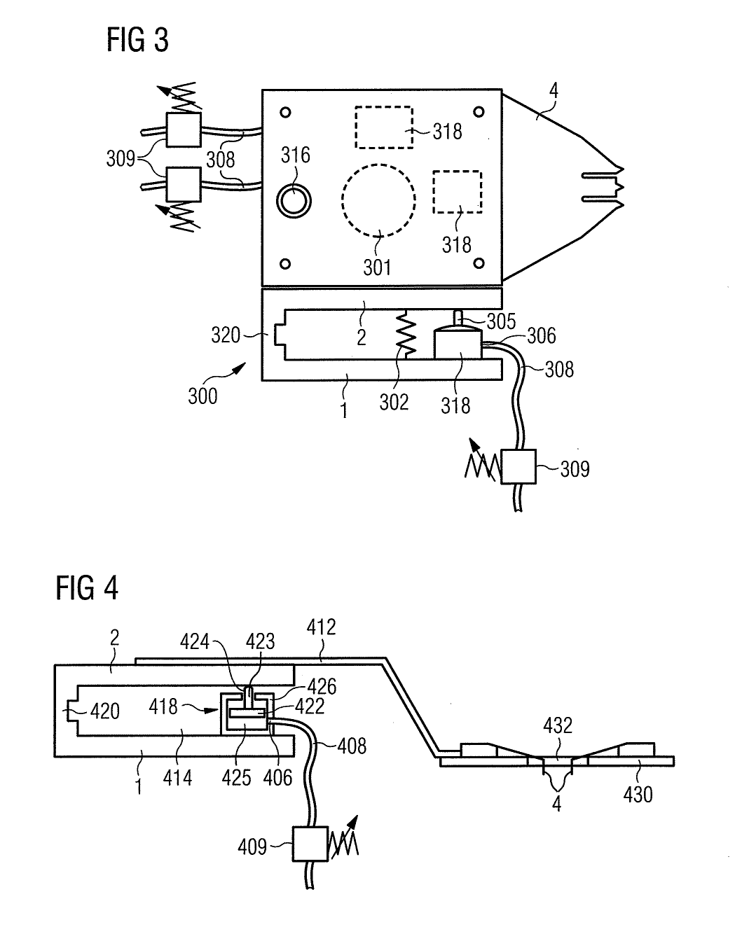

In FIG. 3, a micromanipulator is combined with another micromanipulator 300. The combination between the above described micromanipulator is represented as FIG. 1 and FIG. 2. However, further embodiments of micromanipulators can be combined, depending on the movement to be carried out.

As shown in FIG. 1 and 2, the z-component of the movement course is the bigger one based on the orbit 211 of the present embodiment. In FIG. 3, the z-component stands vertically on the drawing layer. The bigger movement component of the other complementary micromanipulators 300 stands vertically to the z-direction and is consistent with the movement direction of the pusher 205.

The complementary micromanipulator 300 as FIG. 3 comprises a base element 1 and a positioning element 2 which together have the shape of a clamp, and are made as one component in one-piece. The intermediary segment 320 connecting both elements is at least partially tapered so that a pivoting of the positioning element 2 towards and away from the base element 1 is possible.

In an alternative embodiment, the base element 1 and the positioning element 2 can be made of two parts connected through a flexible joining element which allows these movements of the positioning element 2.

Also, the complementary micromanipulator 300 has an actuator 318. Regarding its general construction, it can be referred to the descriptions above as this is consistent with the in the represented embodiment above described actuator. However, the actuator of the complementary micromanipulator 300 has a fluid inlet 307 but no outlet. This complementary micromanipulator 300 moves the other micromanipulator, wherein the movement can be stabilized within the combination due to the absence of the fluid outlet.

Also, the restoring element 302 is presented as a coil spring in the represented embodiment, wherein this is merely a representation in principle, which can be implemented by equally operating embodiments. In one embodiment of the micromanipulator, the restoring element 302 is arranged adjacent to the actuator 318, whereby the necessary restoring force can be reduced.

In the represented combination of two micromanipulators, the first micromanipulator, which carries and directly moves the probe, is moved by the movement of the positioning element 2 of the complementary micromanipulator 300.

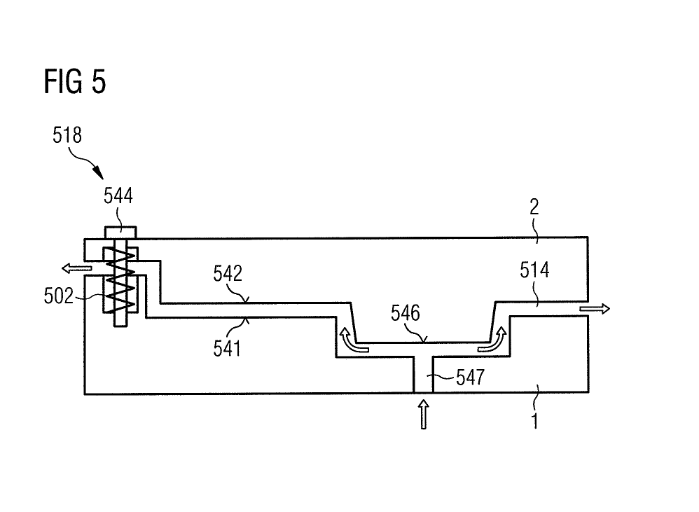

In FIG. 4, different modifications of the individual components of the micromanipulator are presented, which can be combined differently in the embodiments of the micromanipulator.

Thus, the restorement of the positioning element can be assured by the operating method of the micromanipulator. In one embodiment, the positioning element 2 and the base element 1 have a one-piece clamp-like shape including a flexible intermediary segment 420 which enables the movement of the positioning element 2 relative to the base element 1. By use of the actuator 418, the distance between the two elements is increased so that the intermediary segment 420 is prestressed, and a movement of the positioning element 2 can be carried out at an increase as well as at a decrease of the pressure. Also in this case, the intermediary segment 420 is alternatively replaceable by an embodiment of the positioning element 2 and the base element 1 consisting of two parts with a flexible joining element.

More probes 4 are arranged onto the positioning element 2. In the represented embodiment, the probes 4 are testing heads which are arranged onto a probe card 430, and protrude through an opening 432 in the probe card 432. The probe card 430 is connected to the positioning element using a beam 412.

Furthermore, FIG. 4 presents another embodiment of the actuator 418. The actuator 418 comprises a piston 422, whose piston head 422 is moveable in a cylinder 426, and whose piston rod 423 is led through an opening in a base plate of the cylinder 426. The diameter of the piston head 422 and the inner diameter of the cylinder 426 are dimensioned in such a way that a gap is left between the two. Also, there is a gap between the piston rod 423 and the channel in the base plate of the cylinder 426. Both gaps are dimensioned in such a way that the piston can slide into the cylinder 426 without any tilting of the former, but that also a gas or fluid exchange can take place between the volume of the cylinder 426 and the surrounding space. Also, both gaps together serve in this embodiment as a defined leakage in order to allow a dynamic control. Alternatively, the piston head 422 can be arranged in a sealing manner in the cylinder 426 as well as a fluid outlet at the cylinder.

A fluid can be led into the operating volume, that is the internal space of the cylinder between its closed base plate and the piston head 422, through an inlet pipe 408 and through a fluid inlet 406. The piston moves in the cylinder 426 due to the pressure change of the fluid using an adequate control element 409. Because the piston rod head 424 is mechanically connected to the positioning element 2, and the cylinder 426 with its closed base plate is arranged onto the base element 1 within the clearance 414 between the base element 1 and the positioning element 2, the movement of the piston causes an alteration of the distance between the base element 1 and the positioning element 2, and thus, causes the movement of probe 4 in an orbit. Due to the distance between the heads of the probes 4 and the turning point in the intermediary segment 420 of the micromanipulator, the z-component is the predominant direction component of a movement alongside this orbit.

A further embodiment of a micromanipulator is presented in FIG. 5. In this case, the base element 1 and the positioning element 2 are positioned opposite to each other at a defined distance, wherein the opposing surfaces, in the following identified as inside surface, are formed with corresponding topographies, comparable to a die and a die-plate.

Both elements are connected in a border area through adequate joining elements 544 in such a way, that both topographies are opposite to each other with a clearance 514 in between. In order to enable the positioning element 2 to pivot from the in FIG. 5 presented position, the positioning element in the border area where the connection of both elements is made is tapered to the extent, that the necessary distortion of the positioning element 2 is possible due to the flexible characteristics of the material without causing any damage to the micromanipulator. Alternatively, a connection of both elements using a flexible joining element or an articulated joint or similar is possible.

In the area where both elements are connected, a coil spring is arranged as a restoring element 502 in order to generate a defined force for the restorement.

The inside surface of the positioning element 542 has a plane surface in a segment not directly adjacent to the border of the positioning element 2, and which on the inside area of the base element 541 opposes an opening through the base element 1. The plane surface is aligned in such a way that the straight lines defining the surface are in an angle of less than 90° to the possible pivoting direction of the positioning element.

A fluid current is directed through the opening onto the opposite plane surface in an angle of about 90°. Thus, the opening represents a nozzle, and the plane surface a collision surface over which an dynamic pressure arises. The fluid directed onto the collision surface escapes through the clearance 514 between the positioning element 2 and the base element 1 into the surrounding space. The dynamic pressure acting directly upon the positioning element 2 causes the appearance of an initial state, and a pivoting movement of the positioning element 2 through an alteration of the dynamic pressure as already described above in detail.

Due to the connection between the base element 1 and the positioning element 2 in their border area causing the positioning element 2 to move in a pivoting manner having the joint as the swivel axe, such surface segments of the inside surface of the positioning element 542 which run approximately parallel to the pivoting orbit are provided with a bevel, so that an unobstructed pivoting is possible. It is understood that the corresponding segments of the inside area of the base element 541 can have alternatively or additionally a bevel. As a result of these bevels an unobstructed drainage of the fluid through the clearance 514 is possible also in a position into which the positioning element 2 is pivoted away from the position as in FIG. 5.

Also, the present embodiment allows modifications for an adaptation, for instance, to different dimensional parameters, to the fluid used, to the conditions within the probing system such as pressure, temperature or shielding, or to the design of the probes.

1. Micromanipulator for moving a probe, comprising:
a base element,
a positioning element,
wherein said positioning element and said base element are mechanically connected so that the positioning element is movable relative to the base element in at least one direction, and
a mobile actuator mechanically linked to the positioning element and upon which fluctuating pressure of a fluid acts,
wherein a movement of the positioning element occurs by use of a movement of the actuator as a result of a pressure change of the fluid.

2. Micromanipulator of claim 1, wherein the actuator includes a hollow part, whose volume changes corresponding to a pressure change of the fluid due to change of position of at least one of exterior walls, and a coupling element, which is in mechanical contact to the positioning element and a respective exterior wall of the hollow part.

3. Micromanipulator of claim 2, wherein the hollow part includes a defined fluid outlet.

4. Micromanipulator of claim 1, wherein the actuator comprises a piston having a first head in mechanical contact with a positioning element and a second head which slides in an opening of a cylinder in a sealing manner, when the piston is moving in the cylinder as a result of a pressure change of the fluid.

5. Micromanipulator of claim 4, wherein the cylinder comprises a defined fluid outlet.

6. Micromanipulator of claim 1, further comprising a restoring element for restoring position of the positioning element to a previous state.

7. Micromanipulator of claim 1, wherein said base element and said positioning element are pivotally connected by a pivotal connection so that the positioning element is movable relative to the base element in said direction, wherein said pivotal connection comprises a restoring element for restoring position of the positioning element to a previous state.

8. Micromanipulator of claim 7, wherein said pivotal connection is adjacent to the actuator.

9. Micromanipulator of claim 7, wherein the pivotal connection comprises a hinge.

10. Micromanipulator of claim 9, wherein the hinge is a ball and socket hinge.

11. Micromanipulator of claim 1, wherein said base element and said positioning element are connected in a connection by a flexible element so that the positioning element is movable relative to the base element in said direction, wherein said connection comprises a restoring element for restoring position of the positioning element to a previous state.

12. Micromanipulator of claim 1, wherein said base element and said positioning element comprise one-piece in form of a clamp, with a flexible connecting segment which connects said base element to said positioning element and allows a restorement of the positioning element to a previous state.

13. Micromanipulator of claim 1, wherein the micromanipulator is connected to a complementary micromanipulator and is movable in another direction by said complementary micromanipulator.

14. Micromanipulator for moving a probe, comprising:
a base element,
a positioning element,
wherein said positioning element and said base element are mechanically connected so that the positioning element is movable relative to the base element in at least one direction,
a restoring element for restoring position of said positioning element to a previous state, and
wherein a movement of the positioning element occurs due to pressure change of a fluid, which escapes through a nozzle on a defined surface segment of the positioning element.

15. Micromanipulator of claim 14, wherein said base element and said positioning element are pivotally connected in a pivotal connection so that the positioning element is movable relative to the base element in said direction, wherein said pivotal connection comprises a restoring element for restoring the position of the positioning element to the previous state.

16. Micromanipulator of claim 14, wherein said base element and said positioning element are connected by a flexible element.

17. Micromanipulator of claim 14, wherein said base element and said positioning element comprise one-piece in shape of a clamp, with a flexible connecting segment which connects the base element to the positioning elements and allows a restorement of the positioning element to the previous state

18. Micromanipulator of claim 14, wherein said base element and said positioning element are connected by guide means for moving of the positioning element In said direction, wherein said guide means comprises a restoring element for restoring the position of the positioning element to the previous state.

19. Micromanipulator of claim 14, wherein the micromanipulator is connected to a complementary micromanipulator and is movable in another direction said complementary micromanipulator.
